(19) United States
(12) Patent Application Publication
(10) Pub. No.: US 2013/0188912 A1
(43) Pub. Date: Jul. 25, 2013

(54) OPTICAL SWING CONNECTOR, OPTICAL COUNTER CONNECTOR AS WELL AS OPTICAL CONNECTING UNIT

(71) Applicants: Bodo Armin Bastion Bimboese, Frankfurt am Main (DE); Robert Wuerker, Frankfurt am Main (DE)

(72) Inventors: Bodo Armin Bastion Bimboese, Frankfurt am Main (DE); Robert Wuerker, Frankfurt am Main (DE)

(73) Assignee: TYCO ELECTRONICS AMP GMBH, Bensheim (DE)

(21) Appl. No.: 13/876,846

(22) PCT Filed: Sep. 23, 2011
(86) PCT No.: PCT/EP2011/066596

§ 371 Date: Mar. 28, 2013

(30) Foreign Application Priority Data
Oct. 1, 2010 (DE) 10 2010 041 874.9

(51) Int. Cl. G02B 6/42; G02B 6/36

(52) U.S. Cl. CPC G02B 6/4285; G02B 6/3604
USPC 385/60; 385/90

(57) ABSTRACT

The invention relates to an optical swivel connector (100) for an optical, optoelectrical or optoelectronic connection, with in particular a floating ferrule, the optical swivel connector (100) being able to be provided on an optical mating connector (200) such that the swivel connector (100) can be pivoted out of an open position (O) into a closed position (G) on the mating connector (200), an optical means (120) of the swivel connector (100) being able to be optically coupled to an optical means (220) of the mating connector (200). Further, the invention relates to an optical mating connector (200) for an optical, optoelectrical or optoelectronic connection, in particular a transmitter module, receiver module or transmitter/receiver module, the mating connector (200) having a bearing means (230) on/in which an optical swivel connector (100) can be provided such that the swivel connector (100) can be pivoted out of an open position (O) into a closed position (G) on the mating connector (200), an optical means (220) of the mating connector (200) being able to be optically coupled to an optical means (120) of the swivel connector (100). Furthermore, the invention relates to an optical connecting means (10), an assembled optical-waveguide cable (6), in particular a pigtail (6), and also to an electrical or electronic device (1) for the automotive sector, or an assembly (2) therefor.

The invention relates to an optical swivel connector for an optical, optoelectrical or optoelectronic connection, in particular with a floating ferrule; and also to an optical mating connector therefor, in particular a transmitter module, receiver module or transmitter/receiver module. Further, the invention relates to an optical connecting means for an optical, optoelectrical or optoelectronic device, e.g. an MOST device for the automotive sector; an assembled optical-waveguide cable, in particular a pigtail, therefor; and also an electrical or electronic device, or an assembly for this device.

The transmission of data plays an important role in the development of electrical and electronic markets. Nowadays, these data transmission requirements are a crucial component of virtually any branch of industry, such as the computer, automobile or aircraft industry. Therein, broad product ranges of electrical, optical and electro-optical connectors which ensure high data transmission rates are required. These are, e.g. in a modern motor vehicle, entertainment/infotainment applications and traffic information, which is preferably exchanged via what is called an MOST® bus (MOST: Media Oriented Systems Transport), an optical bus of a multimedia network of the motor vehicle. For these and also other optical data transmission technologies, connector systems are required which optically couple the optical or optoelectronic components, such as pigtails, (hybrid) plug connectors with optical and/or electrical contacts and also glass or plastics-material optical-waveguide cables together.

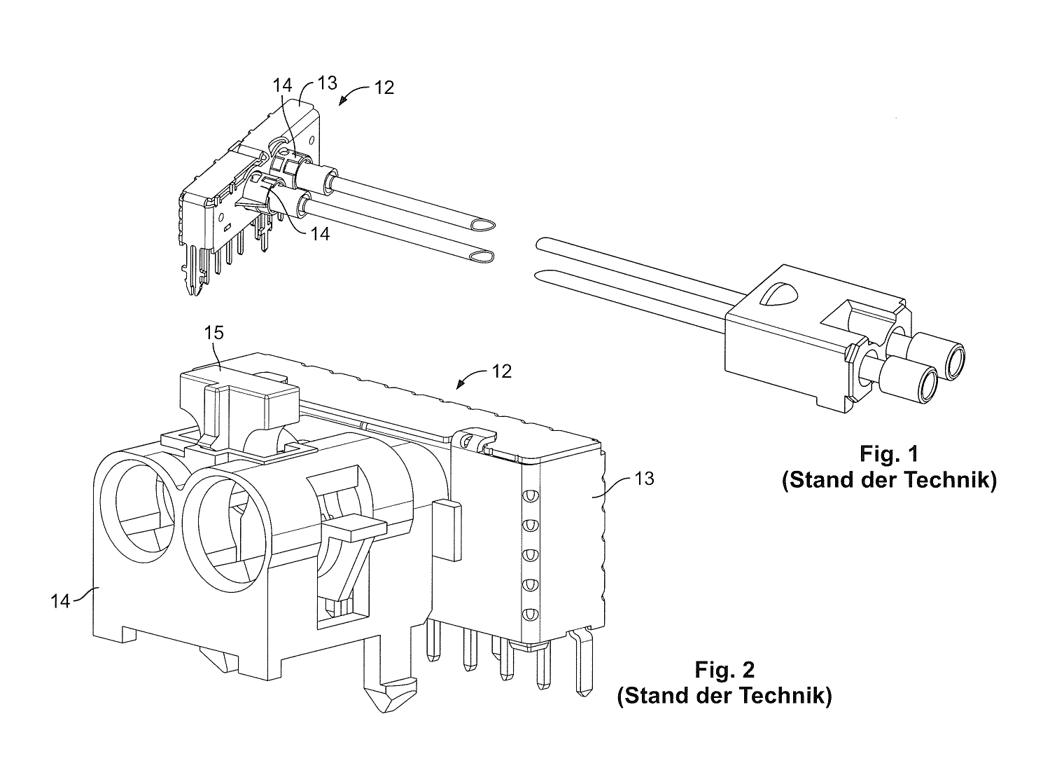

Optical, optoelectrical or optoelectronic connections in the prior art, as illustrated in FIGS. 1 and 2 of the drawings, are designed as optical plug-in connections 12. The optical plug-in connection 12 in such case comprises a wired substrate module 13 with THM technology (THM: Through Hole Mounted), which can be electrically connected on a printed circuit board (PCB) or an assembled board (populated printed circuit board). Further, the plug-in connection 12 comprises, corresponding to its substrate module 13, at least one plug 14 (embodiment according to FIG. 1) or a plug module 14 (embodiment according to FIG. 2).

A pigtail illustrated in FIG. 1 can be supplied substantially only in the embodiment illustrated therein, i.e. with an established plug-in connection 12. In this case, the at least one plug 14 with its optical waveguide is usually mounted on the substrate module 13 by means of a bayonet lock. In the case of a design according to FIG. 2, the pigtail can be produced externally. Initially, e.g. at a customer's premises, an optical-waveguide cable together with the ferrule thereof is mounted on/in the plug module 14, which ferrule can further be latched in the plug module 14 by means of a separate secondary latching means 15. Following this timewise, the plug module 14 is optically connected to the substrate module 13. This pigtail which is thus produced can then be mounted on a printed circuit board.

In the case of such optical plug-in connections 12 which are already established, it is problematic to mount and solder them on a printed circuit board. This stems from the fact that a remnant of the pigtail, optionally with a further optical plug connector for a connector means located opposite the plug-in connection 12, is associated with the plug-in connection 12. This pigtail is comparatively difficult to handle owing to its bulkiness, it being possible for damage to occur on the assembled board or printed circuit board upon the mounting of the plug-in connection 12 owing to the spatial extent of the pigtail. Further, in the subsequent soldering process problems occur with optical waveguides on a plastics-material or polymer basis (POF: Polymer/Plastic Optical Fibre), since these have a comparatively low melting point. Here, it is necessary to use optical waveguides on a glass basis (GOF: Glass Optical Fibre), which makes a particular pigtail significantly more expensive.

Further, the mounting of the pigtail or a lateral plug-in mounting of a plug or of a plug module on a substrate module requires a comparatively large amount of space on the printed circuit board or assembled board which cannot be much used otherwise. Such lateral plug-in mounting is expensive and preferably only carried out in automated manner, since the plug or the plug module has to be guided a considerable way above the printed circuit board, and, towards the end of the mounting, parallel close along the printed circuit board or assembled board. Mounting by hand is often difficult with densely populated printed circuit boards. However lack of ability to carry out mounting by hand makes small batches comparatively expensive, since it is scarcely worthwhile to set up an automatic placement machine. If however mounting is carried out by hand, the risk of rejects increases.

It is an object of the invention to devise an improved optical connection for an optical, optoelectrical or optoelectronic device or an assembly therefor, and/or an improved assembled optical-waveguide cable, such as a pigtail. In this context, it is an object of the invention to devise an improved optical connector and/or an improved optical mating connector for an improved or alternative optical connecting means. Furthermore, accordingly an assembled optical-waveguide cable and/or an electrical or electronic device, or an assembly therefor, should be devised.

According to the invention, mounting of the optical connecting means, in particular mounting of the optical mating connector on a printed circuit board/assembled board and/or the mounting of the optical connector on the mating connector, should be improved; the respective mounting should be able to be carried out simply by hand and also simply in automated manner. In such case, in particular a pigtail should be able to be handled better, or the pigtail should not have to be mounted on the printed circuit board together with the entire optical connecting means. Furthermore, optical waveguides based on plastics material or polymer should also be able to be used in a soldering process of the mating connector on the printed circuit board. Further, less space should be needed on the printed circuit board for the mounting of the pigtail.

The object of the invention is achieved by means of an optical swivel connector for an optical, optoelectrical or optoelectronic connection, with in particular a floating ferrule, according to Claim 1; by means of an optical mating connector likewise for an optical, optoelectrical or optoelectronic connection, in particular a transmitter module, receiver module or transmitter/receiver module, according to Claim 5; by means of an optical connecting means for a device, e.g. an MOST device for the automotive sector, according to Claim 9; by means of an assembled optical-waveguide cable, in particular a pigtail, for an MOST device in the automotive sector, according to Claim 14; and by means of an electrical or electronic device for the automotive sector, or an assembly therefor, according to Claim 15. Advantageous developments of the invention will become apparent from the dependent claims.

The optical connecting means according to the invention has a swivel connector and a mating connector, the swivel connector being able to be provided and/or being provided on the mating connector such that by means of the swivel connector a first optical means of the connecting means can be moved towards, in particular pivoted towards, a second optical means of the connecting means. In a state of the two connectors when they are moved together, the optionally two optical means in each case are optically coupled together, and can therefore transmit light signals. In such case, both the swivel connector and the mating connector may be formed like an optical swivel connector according to the invention or like an optical mating connector according to the invention; see below on this point. Very generally, the swivel connector and the mating connector are configured as connectors which correspond to each other.

In such case, in the case of a one-piece optical connecting means the swivel connector may already be provided on the mating connector, i.e. the swivel connector is already articulated to the mating connector. In the case of a two-piece optical connecting means, the swivel connector may be able to be provided on the mating connector, i.e. the swivel connector is provided on the mating connector only for the establishing of an optical connection. Timewise before the establishing of the optical connection by the two optical means, a bearing means of the swivel connector can be provided or is provided on/in a bearing means of the mating connector. In such case, the two bearing means may be configured such that they can be provided free of force on/in one another and/or cooperate in substantially play-free manner upon pivoting the swivel connector on the mating connector.

The swivel connector can be pivoted out of an open position on the mating connector into a closed position on the mating connector, the swivel connector in the closed position being fastened to the mating connector, in particular latches thereon. In the open position, an optical axis of the optical means of the swivel connector assumes preferably a right-angle or a smaller angle relative to an optical axis of the optical means of the mating connector. Other angles can of course be used. Thus the bearing means may be configured such that mounting of the swivel connector on the mating connector can take place at a given angle or in a given angular range which is greater or less than 90°, or in virtually any angular position of the optical axes whatsoever. Further, the swivel connector can e.g. also be pivoted counter to its closing direction on the mating connector, so that in embodiments of the invention the optical axes may assume an angle of more than 90° relative to each other.

In embodiments of the invention, a bearing shell spans, or the bearing surfaces of an individual bearing means of the mating connector which are associated with each other span, a substantially circular-cylindrical space. A bearing journal of the swivel connector can be provided rotatably in the bearing shell or between the bearing surfaces or is already provided rotatably therein. The bearing journal in this case may have a substantially circular or oval, preferably elliptical, cross-section. If the cross-section is oval, it is preferred for this cross-section to have at least one axis of symmetry. If the cross-section of the bearing journal is oval or elliptical, a distance between the major vertices preferably substantially amounts to a diameter of the space spanned by the bearing shell or the bearing surfaces.

Preferably the bearing shell or the associated bearing surfaces of the mating connector have a bearing slot such that the bearing journal of the swivel connector can be advanced into the bearing means therethrough. In such case, the bearing journal is advanced into the bearing means substantially parallel to the later pivot axis thereof on the mating connector. If the bearing journal has a circular cross-section, a width of the bearing slot is preferably smaller than a diameter of the cross-section of the bearing journal. Upon advancing the bearing journal into the bearing shell, the sides of the bearing shell are widened, the bearing journal then being received substantially in positive manner in the bearing shell or between the bearing surfaces thereof. That is to say that the bearing journal is clicked into the bearing shell.

If the bearing journal has an oval or elliptical cross-section, a width or a diameter of the bearing slot corresponds to at least a distance between the minor vertices of this oval or elliptical cross-section. This means that the bearing journal, provided that it is advanced with a major vertex leading towards the bearing slot, can be advanced into the bearing shell free of force. If in this case the distance between the major vertices of the cross-section of the bearing journal amounts to the diameter of the bearing shell, the bearing journal, after the advancing free of force into the bearing shell, is received therein in play-free manner in the closed position. This results from the geometry of the bearing journal and the bearing shell or the bearing surfaces thereof, and also from the turning of the bearing journal in the bearing shell by up to 90° out of the open position into the closed position.

In preferred embodiments of the invention, in the closed position of the connecting means exclusively a primary latching means of the swivel connector presses the optical means thereof against the optical means of the mating connector. In such case, the optical means of the mating connector provides a spring force on the optical means of the swivel connector, so that the two optical means lie mechanically against one another without an end-face gap all the way through therebetween, i.e. are optically coupled together. Preferably the spring force of the optical means of the mating connector results from the fastening thereof to the printed circuit board.

The individual optical swivel connector according to the invention can be mounted on an optical mating connector such that the swivel connector can be pivoted out of an open position into a closed position on the mating connector; this closed position also corresponds to the closed position of the connecting means according to the invention (see above). In such case, an optical means of the swivel connector is mechanically coupled to an optical means of the mating connector. For this, the swivel connector has a bearing means by means of which the swivel connector can be mounted on the mating connector pivotably about a pivot axis. The bearing means in this case preferably comprises a tab, which is formed in particular in one piece in terms of material with a housing of the swivel connector and preferably protrudes outwards therefrom. Preferably the tab has a bearing journal as bearing means proper.

In embodiments of the invention, the swivel connector has two bearing means laterally provided thereon, which in particular are formed in one piece in terms of material with the swivel-connector housing. The two bearing journals of the bearing means in this case preferably project outwards from the swivel-connector housing or the tab in question, and are in particular formed in one piece in terms of material with the swivel-connector housing or the tab. Further, the pivot axis defined by the swivel connector has a vertical distance from an optical axis of the optical means of the swivel connector. That is to say that the optical means or the optical axis thereof can thereby be guided on a circular path without the optical means being rotatable about an axis passing through the optical axis thereof. The optical axis in such case is at a tangent to this circular path.

Furthermore, a primary latching means of the optical means is preferably formed as a spring shackle, the longitudinal end of which locks the optical means in a direction of its optical axis. In cooperation of the primary latching means with an inward-facing projection of the swivel-connector housing, the optical means is held in both directions of its optical axis. Preferably the optical means is an optical end sleeve or a ferrule. In such case, the swivel connector is preferably configured such that two optical means are provided. Further, the swivel connector may be constructed as discussed above in relation to the connecting means according to the invention.

The individual optical mating connector according to the invention has a bearing means such that an optical swivel connector can be mounted on/in the bearing means. In such case, the swivel connector can be pivoted out of an open position into a closed position on the mating connector; this closed position also corresponds to the closed position of the connecting means according to the invention (see likewise above). In such case, an optical means of the mating connector is mechanically coupled to an optical means of the swivel connector. The bearing means of the mating connector is preferably configured such that a bearing means of the swivel connector can be received thereon/therein. The swivel connector in this case can be mounted on the mating connector pivotably about a pivot axis.

In embodiments of the invention, the bearing means of the mating connector is a bearing shell or bearing surfaces which are associated with each other, which is or are preferably provided on a tab which is attached in particular in one piece in terms of material to a housing of the swivel connector. Preferably a bearing journal of the bearing means of the swivel connector can be received on/in the bearing shell or between the associated bearing surfaces. Preferably the mating connector has two bearing means provided thereon, which in particular are formed in one piece in terms of material with the mating-connector housing.

The pivot axis for the swivel connector which is defined by the mating connector has a certain distance from an optical axis of the optical means of the mating connector; see on this point also the statements in relation to the individual swivel connector according to the invention. Further, a secondary latching means for the optical means of the swivel connector is preferably formed as an inner housing wall of the mating-connector housing. For this, the mating-connector housing is preferably formed such that in the closed position an end face of the secondary latching means holds the optical means of the swivel connector in a direction of the optical axis of the optical means of the mating connector.

The optical means of the mating connector is preferably an electrical optical converter (EOC), in particular an LED or a laser diode, and/or an optical electrical converter (OEC), in particular a photodiode or a phototransistor. Further, the optical mating connector is preferably formed as a surface-mountable component, the electrical connections of which can be mounted on a substrate, such as the printed circuit board. In such case, preferably both the optical means and also an EMC protection means of the mating connector have surface-mountable electrical connections, in particular electrical connecting pins. Further, the mating connector may be extended [sic] as discussed above in relation to the connecting means according to the invention.

Mounting of the optical connecting means, in particular mounting of the mating connector on a printed circuit board and/or mounting of the swivel connector on the mating connector, is improved according to the invention. In such case, the mounting can be carried out in simple manner by hand and also in simple manner by automation. Owing to the separation according to the invention of an optical plug-in connection into a swivel connector and a mating connector, in particular a pigtail can be handled better or the pigtail does not have to be mounted on the printed circuit board together with the entire connecting means according to the invention. This means that optical waveguides on a plastics material or polymer basis can be used without problems. Furthermore, less installation space on the printed circuit board is required for mounting the entire pigtail.

One further advantage is that an assembler no longer has to insert the ferrules individually in the case of manual assembly. This avoids the risk of transposing.

The invention will be explained in greater detail below using examples of embodiment with reference to the appended drawings. The substantially detailed figures of the drawings show:

FIG. 1 in a perspective view, a pigtail with an optical plug-in connection in accordance with the prior art, having a substrate module and two plugs therefor and also a further optical plug connector;

FIG. 2a perspective view of a substrate module of an optical plug-in connection in accordance with the prior art, with a non-populated plug module provided thereon;

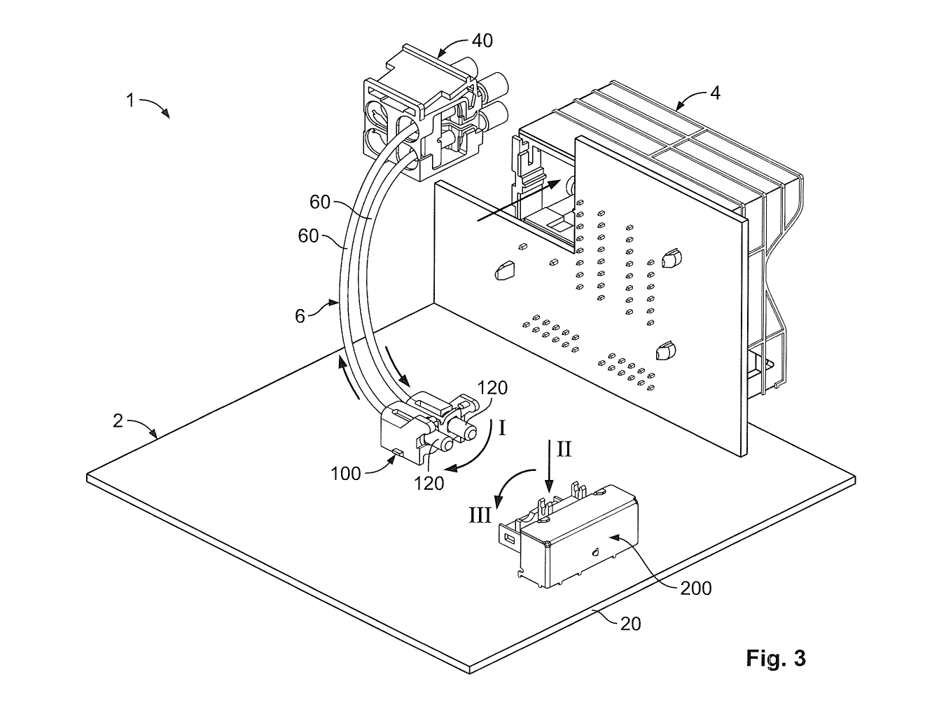

FIG. 3a perspective, cut-out and diagrammatic view of an optoelectronic device according to the invention upon the establishing according to the invention of an optical connection by means of an optical connecting means according to the invention;

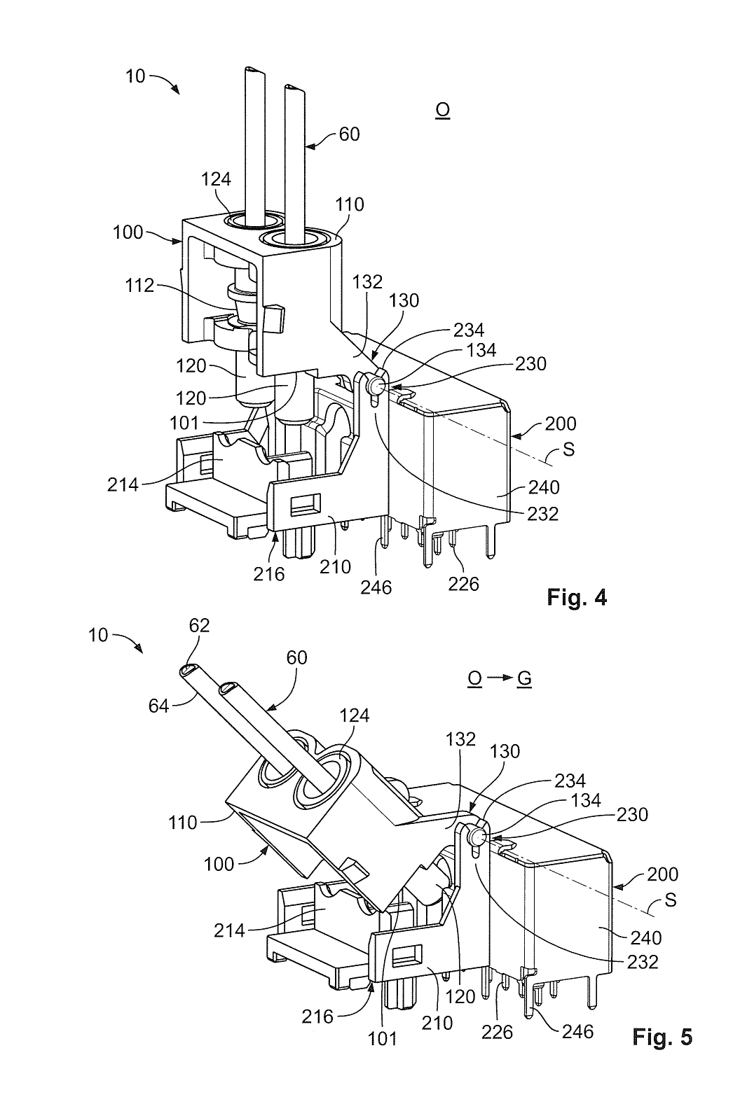

FIG. 4 in a lateral rear 3D view, the provision of an optical swivel connector according to the invention on an optical mating connector according to the invention;

FIG. 5 analogously to FIG. 4, the establishment according to the invention of the optical connecting means according to the invention from the swivel connector and the mating connector;

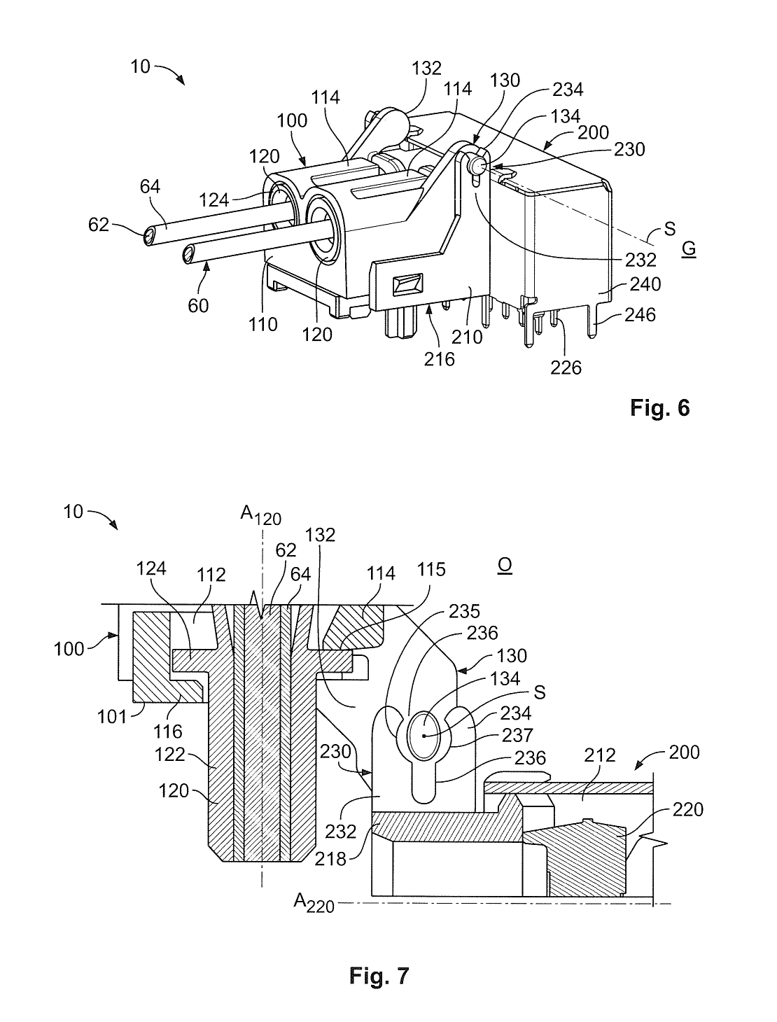

FIG. 6 analogously to FIGS. 4 and 5, an established optical connection consisting of the swivel connector and the mating connector;

FIG. 7 in a laterally sectional 2D view, the insertion of the swivel connector according to the invention on the mating connector according to the invention;

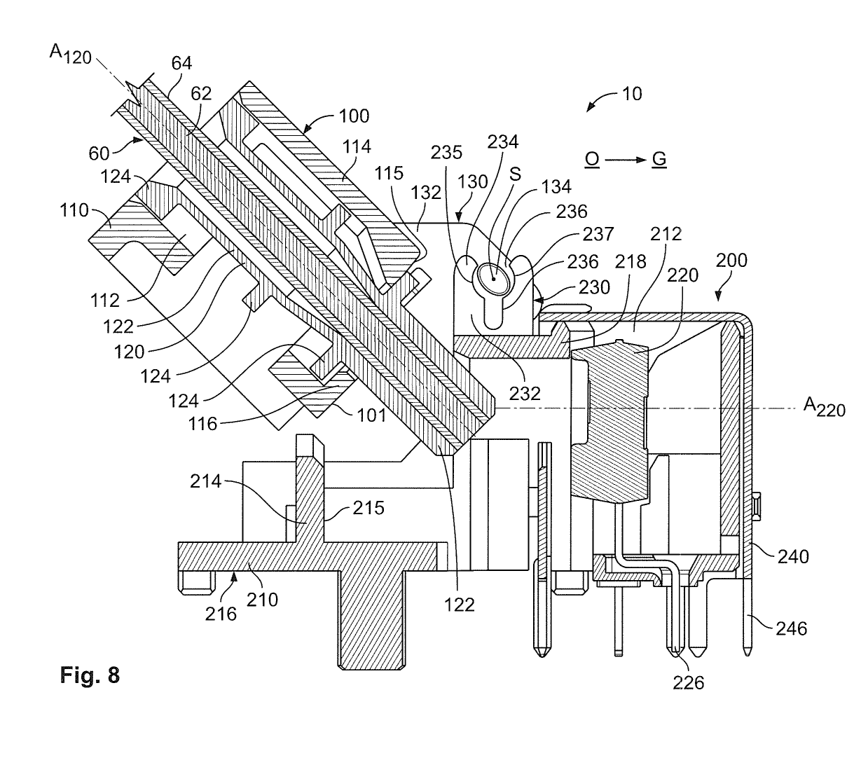

FIG. 8 analogously to FIG. 7, the pivoting of the swivel connector relative to the mating connector out of an open position on the mating connector;

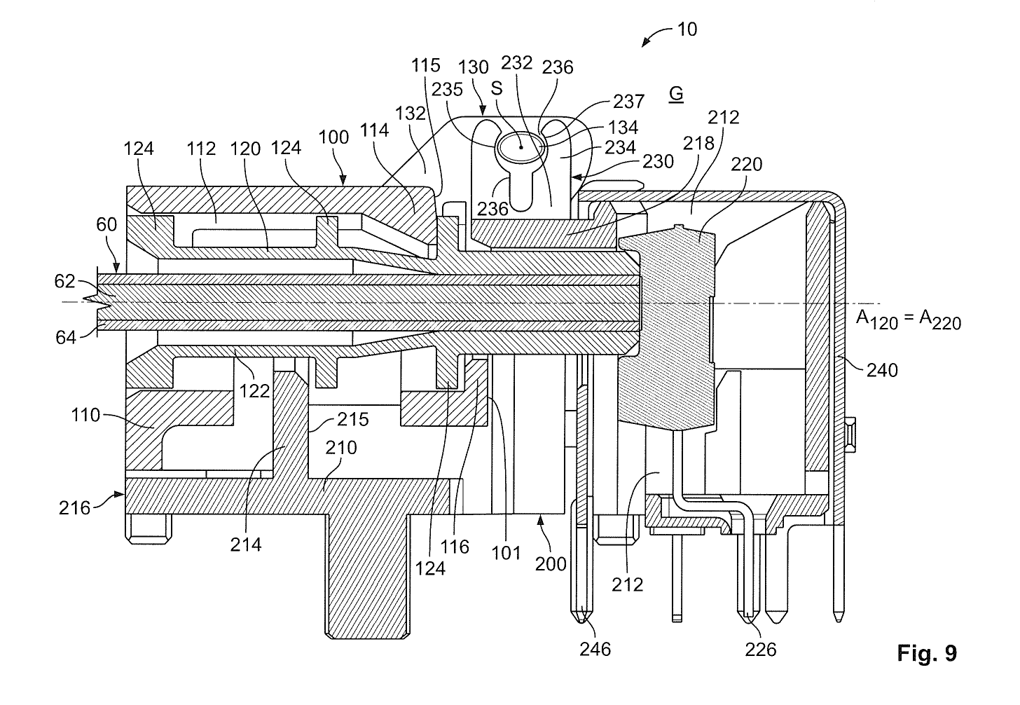

FIG. 9 analogously to FIGS. 7 and 8, a closed position of the swivel connector on the mating connector, with optically coupled optical means;

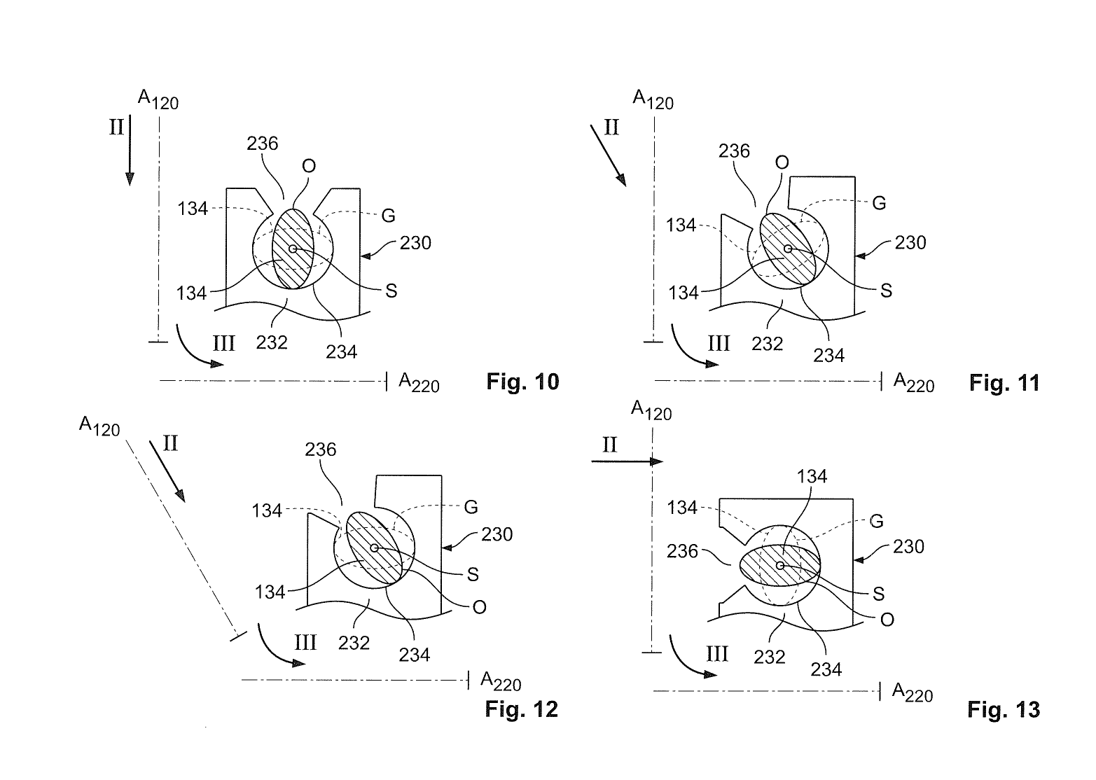

FIG. 10 a diagrammatic 2D side view of an established bearing connection of the swivel connector according to the invention with the mating connector according to the invention;

FIG. 11 in an illustration analogous to FIG. 10, a further embodiment of the bearing connection according to the invention consisting of the swivel connector and the mating connector;

FIG. 12 analogously to FIG. 10, an illustration of an alternative of the embodiment according to the invention of the bearing connection;

FIG. 13 and likewise analogously to FIG. 10, an illustration of a further alternative of the embodiment according to the invention of the bearing connection;

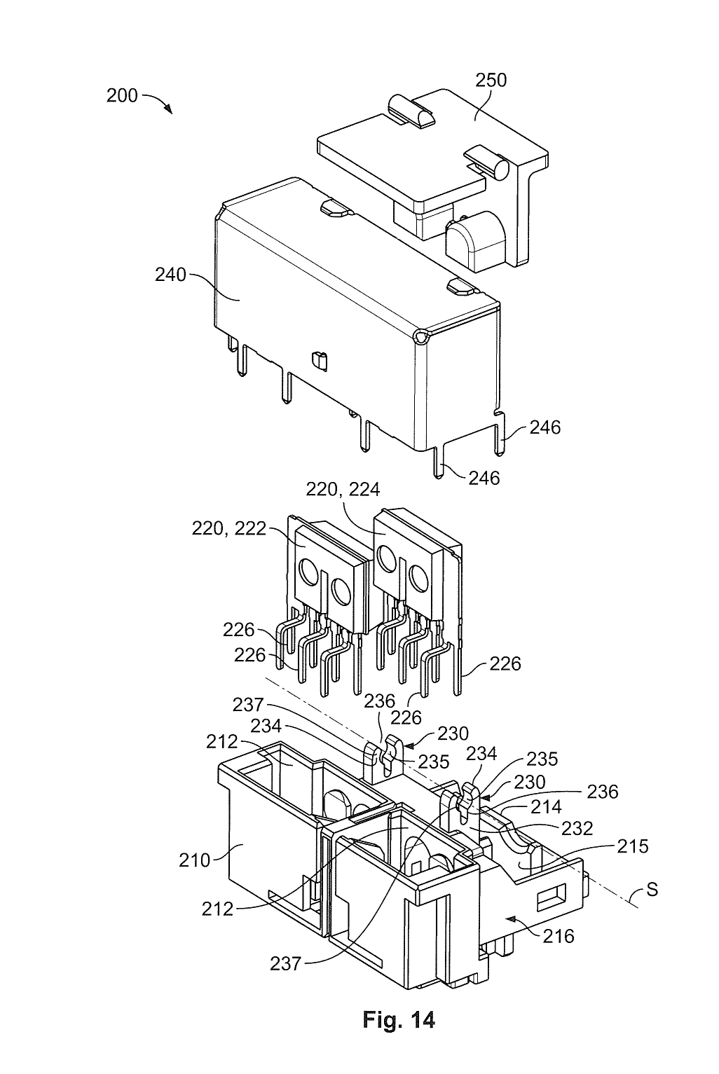

FIG. 14 a three-dimensional exploded view of the mating connector according to the invention; and

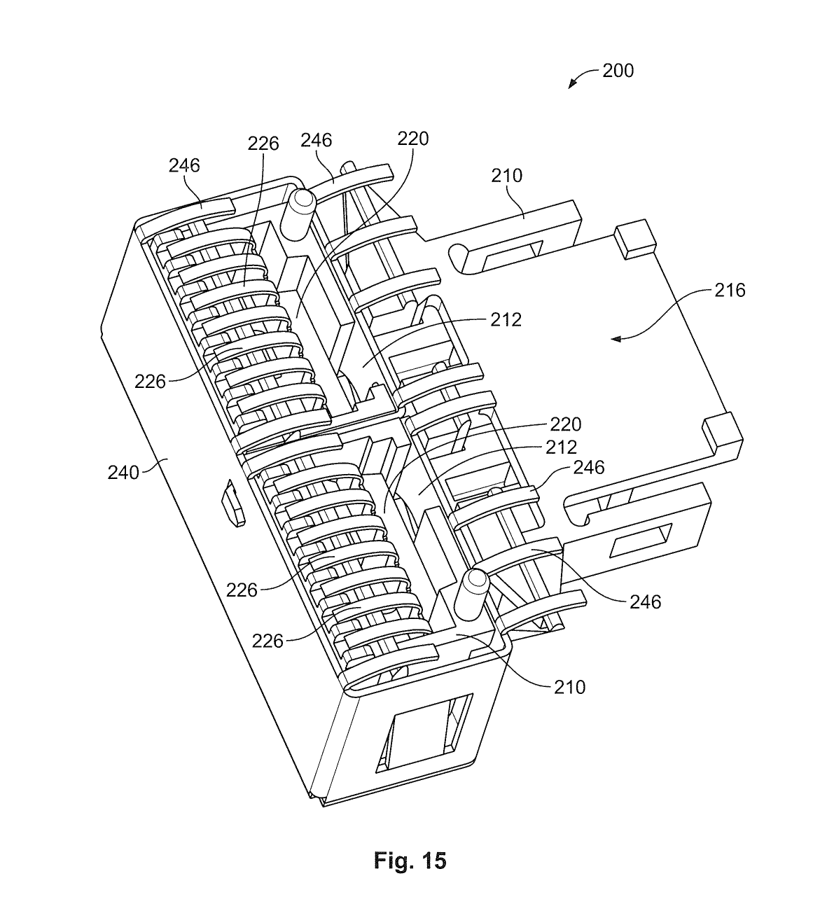

FIG. 15 a perspective view of the mating connector according to the invention from below.

The invention will be explained in greater detail below with reference to a device 1 (see FIG. 3) for an MOST network; preferably this device 1 is a high-frequency means 1 or a radio means 1. The invention is however not restricted to such a device 1, but can be applied to all optical, optoelectrical or optoelectronic devices 1, apparatus 1 and/or means 1.—Further, if a pigtail 6 is discussed below, this is a (pre-)assembled optical-waveguide cable 6, which is preferably comparatively short and is provided at least at one end with an optical connector. This (pre-)assembly is usually necessary, since mounting of the connector with the optical waveguides 60 in question on site is problematic. A pigtail 6 serves e.g. for coupling optical components or allocation of optical connections.

The MOST device 1 partially shown in FIG. 3 is part of an MOST network, the structure of which is preferably a ring, a connection between two MOST devices 1 being formed as a point-to-point connection. A means referred to as an electrical optical converter (EOC, item 220, see below) in this case converts electrical signals in a transmitter/receiver module 200 (MOST Network Transceiver) into optical signals which are transmitted via a preferably polymeric optical waveguide 60 to a second transmitter/receiver module 200 (MOST Network Transceiver); there a means referred to as an optical electrical converter (OEC, 220) converts the received optical signals into electrical signals; the reverse takes place in parallel in this case for a second optical waveguide 60. In the present case, such a transmitter/receiver module 200 is formed as an optical mating connector 200 according to the invention for an optoelectronic connecting means 10 according to the invention, which further comprises an optical swivel connector 100 according to the invention, which is preferably a constituent of the pigtail 6.

The mating connector 200 may however be formed e.g. also only as an optical or electro-optical transmitter module 200 (transmitter) or only as an optical or electro-optical receiver module (receiver). In the present case, the mating connector 200 is formed as a substrate module 200 of the optical connecting means 10 and can be mounted on a substrate 20, e.g. a printed circuit board 20, which may optionally be populated. However, it can also be applied to an optionally encapsulated lead frame 20 as substrate 20 or similar. In such case, the substrate 20 is part of an assembly 2 of the device 1. The connecting means 10 is further optically connected to an optical, optoelectrical/optoelectronic connector means 4, in the present case an MOST connector 4, which is formed in particular as a radio plug connector 4 formed as a pin socket 4. For this, the pigtail 6 has an optical plug connector 40 for the connector means 4 on an opposite end to the swivel connector 100.

The connecting means 10 according to the invention has two connector components 100, 200 which can be pivoted towards each other. In such case, it is preferred for the swivel module 100 to be formed separately from the mating connector 200, these being able to be mounted on one another. In embodiments of the invention, it is however possible to provide the swivel module 100 securely but pivotably on the mating connector 200; i.e. the counter-bearing in question is already provided on/in a respective bearing means. Below, however, only the two-part configuration of the connecting means 10 will be explained in greater detail.

As can be inferred from steps I to III of FIG. 3, the swivel connector 100 initially has to be tilted by approximately 90° out of the horizontal position shown in FIG. 3, such that the optical means 120 thereof point downwards relative to FIG. 3 (step I). Following this timewise, the swivel connector 100 is connected in articulated manner in this relative position, to the mating connector 200 (step II, see also FIGS. 4 and 7), the swivel connector 100 being in an open position O on the mating connector 200. This is also referred to as open position of the connecting means 10. Finally, the swivel connector 100 is again pivoted into a horizontal position with reference to FIG. 3 on the mating connector 200 (step III, see also FIGS. 5 and 8), an optical connection being established between the swivel connector 100 and the mating connector 200 (step III, see also FIGS. 6 and 9). That is to say that the swivel connector 100 is in a closed position G on the mating connector 200; this is referred to analogously as closed position G of the connecting means 10.

A construction of the swivel connector 100 and of the mating connector 200 and establishing of the connecting means 10 will be explained in greater detail below with reference to the external views of FIGS. 4 to 6 and the corresponding internal views of FIGS. 7 to 8. The substantially box-shaped swivel connector 100 has in its housing 110 at least one optical means 120 which is secured, preferably latched, therein. The optical means 120 preferably has axial play in the direction of its optical axis A₁₂₀ in the swivel-connector housing 110. In the present case, the swivel connector 100 has two optical means 120, one for an optical transmitter path and one for an optical receiver path. The optical means 120 in each case is formed as an optical end sleeve 120 or ferrule 120 in the present case; of course other optical means 120 may be provided in the housing 110; see on this point also the explanations in relation to the mating connector 200. Below, only an individual ferrule 120 as optical means 120 is discussed; what is stated below is intended to apply analogously to the second optical means 120.

The ferrule 120 is centred and latched in a chamber 112 in the swivel-connector housing 110. For this, the ferrule 120 has at least one shoulder 124, which runs at least partially around a preferably rotationally symmetrical basic body 122 of the ferrule 120. On an upper side of the housing 110, there is provided integrally a primary latching means 114 formed as a spring shackle 114, the longitudinal end 114 of which or the end face 115 of which is seated in locking manner in a mounting position of the ferrule 120 in the housing 110 on a front shoulder 124 of the ferrule 120. In this case, the ferrule 120 is locked in one direction of its optical axis A₁₂₀. The ferrule 120 is locked in a direction opposed thereto, likewise by means of its front shoulder 124, by means of a projection 116 on a front end face 101 of the housing 110. A play for the ferrule 120 in the direction of the optical axis A₁₂₀ is adjustable by a thickness of the shoulder 124, and an axial distance of the end face 115 of the primary latching means 114 relative to a side located opposite the front end face 101 of the projection 116.

For mounting of the ferrule 120 in the swivel-connector housing 110, said ferrule is advanced inwards into the chamber 112, coming from a rear side, into an outer opening of the chamber 112 of the housing 110. In such case, the front shoulder 124 of the ferrule 120 moves the elongate primary latching means 114 away upwards. If the ferrule 120 is in its final mounting position in the housing 110, the primary latching means 114 engages behind the front shoulder 124. A rear shoulder 124 of the ferrule 120 centres it in the chamber 112, in particular in a region at the rear opening of the housing 110.—In the ferrule 120 there is fastened a longitudinal end section of an optical waveguide 60, which preferably consists of a plastics material or a polymer (POF); of course an optical waveguide 60 made of glass (GOF) can also be used. The optical waveguide 60 has an optical-waveguide core 62 which is surrounded by a coating 64.

The housing 110 of the swivel connector 100 has two bearing means 130 for attachment of the swivel connector 100 to the mating connector 200. In such case, the bearing means 130 act as a swivel bearing means. Below, again only an individual bearing means 130 is discussed; what is stated below is then intended to apply analogously likewise to the second bearing means 130. The bearing means 130 has laterally on the housing 110, protruding upwards or outwards, a nose 132 or a tab 132, which is preferably formed in one piece in terms of material with the housing 110. The nose or the tab may also be formed as a separate component, which is connected to the housing for example via a screw connection. Laterally on the tab 132 there is, facing outwards, a bearing journal 134, which in particular has a circular (see FIGS. 4 to 6), elliptical (see FIGS. 7 to 9) or oval cross-section. It is of course possible also to provide the bearing journal 134 facing inwards. The two bearing journals 134 define a pivot axis or axis of rotation S of the swivel connector 100. Further, the swivel connector 100 may also be referred to as swivel module 100 of the connecting means 10.

The approximately box-shaped mating connector 200 has in its housing 210 at least one optical means 220 which, together with an EMC protection means 240 (see also FIG. 14), can be electrically connected to a substrate 20. In such case, the EMC protection means 240 may be latched to the housing 210. Further, the housing 210 may have mounting means, in particular mounting pins, by means of which it can be mounted on the substrate 20 (see also FIG. 15). The mating connector 200 may also be referred to as a substrate module 200 of the connecting means 10. For receiving the optical means 220, the housing 210 has a chamber 212 which is accessible from the outside on a front side of the housing 210 at least for one end surface of the ferrule 120 of the swivel connector 100. For receiving the ferrule 120 of the swivel connector 100, the housing 210 further has an upper wall 218 which limits the chamber 212 at the top and prevents the ferrule 120 from being provided too high up. The upper wall 218 may have an insertion slope on the front side of the housing 210.

The optical means 220 of the mating connector 200 may be an electrical optical converter 220, 222, such as an LED or a laser diode, and/or an optical electrical converter 220, 224, such as a photodiode or a phototransistor. Other optical means, such as a ferrule or an optical end sleeve, may of course be used. In the present case, the optical means 220 of the mating connector 200 is a transmitter/receiver (transceiver), which comprises an electrical optical converter 222 and an optical electrical converter 224 (see FIG. 14). It is of course possible to provide only a single optical means 220 or a plurality thereof instead of two.

On the front side of the mating-connector housing 210, said housing has a flange 216 which is preferably integral therewith for mounting and establishing of the optical connection with the swivel connector 100. This flange 216 comprises two bearing means 230 for the attachment of the swivel connector 100, it also being possible to refer to the bearing means 230 likewise as a swivel bearing means. The flange 216 in this case has two tabs 232, which are preferably formed in one piece in terms of material with the housing 210 or the flange 216. Below, again only an individual bearing means 230 will be discussed; what is stated is again intended to apply analogously to the second bearing means 230. The tab 232 in this case is preferably arranged parallel to the tab 132 of the swivel connector 100 in the connecting means 10 and has on a free longitudinal end section a bearing shell 234 for the bearing journal 134 of the swivel connector 100.

The bearing shell 234 may in this case be formed closed in the peripheral direction (not shown in the drawings), so that the bearing journal 134 of the swivel connector 100 can be inserted laterally. Preferably the tab 232 is open on its longitudinal end such that the bearing journal 134 can be advanced into the bearing shell 234 through this opening, which is referred to below as “bearing slot” 236. The bearing shell 234, which is preferably formed as a radial bearing 234 or a radial sliding bearing 234, preferably comprises two bearing surfaces 235, 237 which are formed by means of the bearing slot 236. That is to say that the bearing slot 236 preferably passes through the bearing shell 234 at two points located opposite each other, so that the two defined bearing surfaces 235, 237 form, which owing to the bearing slot 236 have a certain resilient mobility relative to each other and thus can compensate for a manufacturing tolerance of the bearing journal 134.

A particular diameter of the bearing journal 134 may in this case be selected to be slightly greater than the distance between the two bearing surfaces 235, 237, in order to ensure play-free receiving of the bearing journal 134 between the bearing surfaces 235, 237. Further, a bearing slot 236 can be used which cuts into the bearing shell 234 on a single side (see FIGS. 10 to 13). The two bearing surfaces 235, 237 are formed in circular manner with an identical radius in an inner cross-section; i.e. the bearing shell 234 or the bearing surfaces 235, 237 span a cylindrical cavity in which the bearing journal 134 can be received in its longitudinal direction. Further, in the case of a bearing slot 236 extending through the bearing shell 234, it is preferable for the section of the bearing slot 236 facing the longitudinal end of the tab 232 to be wider than the section located opposite it within the tab 232 (see FIGS. 7 to 9). The two bearing shells 234 or the associated bearing surfaces 235, 237; 235, 237 in such case form a pivot axis or axis of rotation S for the swivel connector 100 on the mating connector 200.

Further, the flange 216 may ensure secondary latching 214 of the ferrule 120 of the swivel connector 100 in the mating-connector housing 210 or in the flange 216. In such case, then a separate secondary latching means for the ferrule 120 is dispensed with. In such case, the secondary latching means 214 is preferably provided as a housing inner wall 214 projecting within the flange 216 from its base inwards into the flange 216. In the closed position G of the connecting means 10, then an end face 215 of the secondary latching means 214 lies adjacent to a preferably middle shoulder 124 of the ferrule 120. In such case, the end face 215 of the secondary latching means 214 hinders an extraction movement of the ferrule 120 in the direction of the optical axis A₁₂₀ thereof (=A₂₂₀, axial direction or optical axis of the optical means 220), with in this case the middle shoulder 124 being seated on the secondary latching means 214. So that the secondary latching means 214 does not hinder the pivoting movement of the swivel connector 100 on the mating connector 200, said means may be bevelled.

Mounting and pivoting of the swivel connector 100 on or with respect to the mating connector 200 will be explained in greater detail below, with reference being made only to two bearing means 130, 230 which correspond to each other, and what is stated again being intended to apply to the other corresponding bearing means 130, 230. Preferably the bearing journal 134 of the swivel connector 100 is oval or elliptical in its cross-section, so that it has the shape of a cylinder with an oval or elliptical base surface. In the present case, the bearing journal 134 is provided with respect to the optical means 120 on the swivel connector 100 such that the major axis of the cross-section lies parallel to the optical axis A₁₂₀ of the optical means 120. The bearing slot 236 in this case is provided on the mating connector 200 such that the depth-wise extent or longitudinal extent thereof in a lateral projection (see FIGS. 7 to 9) is perpendicular to the optical axis A₂₂₀ of the optical means 220 of the mating connector 200.

The swivel connector 100 is now positioned above the mating connector 200 such that the major axis of the cross-section of the bearing journal 134 points in the direction of the bearing slot 236. Now the swivel connector 100 is moved towards the mating connector 200 until the bearing journal 134 is received in the bearing shell 234 or between the bearing surfaces 235, 237 of the mating connector 200 (open position O, see FIGS. 4, 7 and FIGS. 10 to 13). In such case, the bearing slot 236 is so wide that a smaller or the smallest diameter of the cross-section of the bearing journal 134 can be moved through the bearing slot 236 without problems. The bearing slot 236 is however narrower than that of a greater or the greatest diameter of the cross-section of the bearing journal 134. For simple introduction of the bearing journal 134 into the bearing means 230, the bearing slot 236 may have an insertion slope on one or both sides. Following this, the swivel connector 100 is pivoted towards the mating connector 200 (open position O=>closed position G, see FIGS. 5, 8), the bearing journal 134 being received with the regions of its greatest diameter substantially without play in the bearing shell 234 or between the bearing surfaces 235, 237. That is to say that the relevant diameter of the bearing means 230 corresponds at most substantially to the greatest diameter of the bearing journal 134. In the closed position G (see FIGS. 6, 9 and also 10 to 13), the greatest diameter of the bearing journal 134 lies preferably perpendicular to the bearing slot 236, and the two optical axes A₁₂₀, A₂₂₀ of the optical means 120, 220 of the swivel connector 100 and of the mating connector 200 substantially coincide. The regions of the greatest diameter of the bearing journal 134 have in such case turned away to the maximum extent from the bearing slot 236.

It is of course possible to form a mutual arrangement of the bearing journal 134, the bearing shell 234 or the bearing surfaces 235, 237 thereof and the optical means 120, 220 in many possible embodiments. This is illustrated in FIGS. 10 to 13 by way of example for the swivel connector 100, with no bearing slot 236 all the way through being illustrated here. The following statements can of course be transferred to such embodiments and also to the mating connector 200. In such case, in FIGS. 10 to 13 a cross-hatched cross-section of the bearing journal 134 shows the open position O, and an outline shown in dotted lines of the bearing journal 134 shows the closed position G, of the connecting means 10. FIG. 10 shows once again the above embodiment without a bearing slot 236 all the way through; the major axis of the cross-section of the bearing journal 134 is arranged parallel to the optical axis A₁₂₀ of the optical means 120, and the bearing slot 236 is as far as it can be from the optical axis A₂₂₀ of the optical means 220. The arrows with steps II and III refer in this case to the statements in relation to FIG. 3; i.e. step II for the insertion and step III for the pivoting.

In FIG. 11 part of this arrangement is turned mathematically positively (with reference to FIG. 10 anticlockwise) by approximately 30°. In such case, of course any angles whatsoever, preferably in the region of ±90°, can be used. The optical axes A₁₂₀, A₂₂₀ of the optical means 120, 220 in this case maintain their previous positions from FIG. 10, the swivel connector 100 still having to be turned by 90° on the mating connector 220 in order to reach its closed position G. The major axis of the cross-section of the bearing journal 134 is no longer parallel to the optical axis A₁₂₀ of the optical means 120, but assumes an angle of approximately 30° thereto. Correspondingly, the bearing slot 236 of the bearing shell 234 is also turned mathematically positively by approximately 30° relative to the bearing shell 234 of FIG. 10. The swivel connector 100 in such case in step II is moved obliquely towards the mating connector 200.

In an embodiment according to FIG. 12, compared with the embodiment of FIG. 11 the optical axis A₁₂₀ is also turned by the amount of the bearing journal 134, so that the swivel connector 100 has to be turned by approximately 60° on the mating connector 200 in order to reach its closed position G. In such case, of course again any angles whatsoever, preferably in the region of ±90°, can be used, and these may further be different from the above angles. That is to say that in relation to FIG. 10 the arrangement of the bearing journal 134, the optical axis A₁₂₀ and hence of the optical means 120 and the bearing slot 236 is turned by approximately 30° in the mathematically positive direction. The insertion of the swivel connector 100 in step II again takes place obliquely. In the embodiment of FIG. 13, the arrangement of the bearing journal 134 and of the bearing slot 236 is turned by 90° in the mathematically positive direction in relation to FIG. 10. The optical axes A₁₂₀, A₂₂₀ and hence also the optical means 120, 220 have the position illustrated in FIG. 10. The swivel connector 100 in such case is moved laterally towards the mating connector 200 in step II and, following this, is pivoted by 90°.

In the closed position G of the swivel connector 100 on the mating connector 200, the swivel connector 100 latches on the mating connector 200. See in FIGS. 6 and 15 the latch recess in the flange 216 and the latch projection on the swivel connector 100, which of course can also be embodied the other way round. Further, the swivel connector 100 is seated with a preferably rear stop preferably on a base of the flange 216 of the mating connector 200 (see FIG. 9). Furthermore, FIGS. 4 to 6 show a bearing journal 134 which is circular in cross-section, which likewise can be used in the other embodiments illustrated and explained, as long as the bearing means 230 can be widened correspondingly upon advancing of the bearing journal 134. Further, FIG. 14 shows a protective cap 250 for the optical means 220; 222, 224 of the mating connector 200.

FIGS. 14 and 15 show in each case an electrical connection of the optical means 220; 222, 224 and of the EMC protection means 240 on a printed circuit board 20. The corresponding electrical connections 226, 246 in the embodiment of FIG. 14 are formed as connecting pins 226, 246 which protrude from the component in question, which can be inserted through the printed circuit board 20 (THM technology) and can be soldered on an opposite side of the printed circuit board 20. In the embodiment of FIG. 15, the connecting pins 226, 246 on the component in question are provided bent by approximately 90° and preferably formed as spring shackles, which can contact an electrical connection in question on the surface of the printed circuit board 20. That is to say that the optical means 220; 222, 224 and the EMC protection means 240 are formed as surface-mountable components (SMT) and both can be electrically connected together on the printed circuit board 20. The elongate connecting pins 226, 246 preferably have an arcuate shape when viewed from the side.

It is of course possible to reverse the bearing principle according to the invention kinematically, i.e. the bearing shells 234 or the bearing surfaces 235, 237 are located on the swivel connector 100 and analogously thereto the bearing journals 134 are located on the mating connector 200. Furthermore, it is possible, in each case, instead of a bearing shell 234 or the associated bearing surfaces 235, 237 and the corresponding bearing journal 134, to provide an alternative swivel mounting. This alternative swivel mounting 130, 230 may be combined with a swivel mounting described above, a second alternative swivel mounting or even a further alternative to the alternative swivel mounting. As an alternative swivel mounting, e.g. a guide may be considered, in which a bearing journal or alternatively a different element is guided. Further, two guides which correspond to each other can be assembled to form an individual swivel mounting. Further, of course also an elongate bearing axle can be used instead of the two bearing journals 134.

1-15. (canceled)

16. An optical swivel connector for an optical, optoelectrical or optoelectronic connection, with in particular a floating ferrule,
the optical swivel connector being able to be provided on an optical mating connector such that the swivel connector can be pivoted out of an open position (O) into a closed position (G) on the mating connector, and
an optical means of the swivel connector being able to be optically coupled to an optical means of the mating connector.

17. An optical swivel connector according to claim 16, the swivel connector having a bearing means by means of which the swivel connector can be provided on the mating connector pivotably about a pivot axis (S), and/or
the bearing means having a bearing journal which is preferably provided on a tab which is formed in particular in one piece in terms of material with a housing of the swivel connector and preferably protrudes outwards therefrom.

18. An optical swivel connector according to claim 16, wherein the bearing journal of the swivel connector having a substantially circular or oval, preferably elliptical, cross-section, and
the swivel connector upon the mounting thereof on the mating connector being able to be moved towards the mating connector in the direction of a major axis of the cross-section of the bearing journal,
the bearing journal being able to be advanced through a bearing slot of a bearing shell of the mating connector into the bearing shell.

19. An optical swivel connector according to claim 16, wherein
a distance between the major vertices of the cross-section of the bearing journal corresponds to a diameter of a bearing means of the mating connector,
a distance between the minor vertices of the cross-section of the bearing journal is slightly smaller than a diameter of a bearing slot of the bearing means of the mating connector;
the swivel connector has two bearing means laterally provided thereon, which in particular are formed in one piece in terms of material with the swivel-connector housing;
the two bearing journals of the bearing means of the swivel connector protrude outwards from the swivel-connector housing, and are in particular formed in one piece in terms of material therewith;
the pivot axis (S) defined by the swivel connector has a certain distance from an optical axis (A₁₂₀) of the optical means of the swivel connector;
a primary latching means of the optical means of the swivel connector is formed as a spring shackle, the longitudinal end of which locks the optical means in a direction of its optical axis (A₁₂₀);
the primary latching means in cooperation with an inwards-facing projection of the swivel-connector housing holds the optical means of the swivel connector in both directions of its optical axis (A₁₂₀); and/or
the optical means of the swivel connector is an optical end sleeve or a ferrule, with preferably two optical means being provided.

20. An optical mating connector for an optical, optoelectrical or optoelectronic connection, in particular a transmitter module, receiver module or transmitter/receiver module,
the mating connector having a bearing means on/in which an optical swivel connector can be provided such that the swivel connector can be pivoted out of an open position (O) into a closed position (G) on the mating connector,
an optical means of the mating connector being able to be optically coupled to an optical means of the swivel connector.

21. An optical mating connector according to claim 20, the bearing means of the mating connector being configured such that the bearing means of the swivel connector can be received thereon/therein, the swivel connector being able to be provided on the mating connector pivotably about a pivot axis (S), and/or
the bearing means of the mating connector having a bearing shell which is preferably provided on a tab, which tab is attached in particular in one piece in terms of material to a housing of the swivel connector, a bearing journal of the bearing means of the swivel connector being able to be received on/in the bearing shell.

22. An optical mating connector according to claim 20, wherein the bearing shell of the mating connector having a bearing slot through which the bearing journal of the swivel connector can be advanced, and
the bearing shell forming a circular-cylindrical space for the mounting of the bearing journal of the swivel connector, and the bearing slot preferably being provided on two sides of the bearing shell, so that two bearing surfaces form.

23. An optical mating connector according to claim 20, wherein:
a diameter of the bearing shell of the mating connector corresponds to a distance between the major vertices of a cross-section of the bearing journal of the swivel connector;
a diameter of the bearing slot corresponds to at least a distance between the minor vertices of the cross-section of the bearing journal of the swivel connector;
the mating connector has two bearing means provided thereon, which in particular are formed in one piece in terms of material with the mating-connector housing;
the pivot axis (S) for the swivel connector which is defined by the mating connector has a certain distance from an optical axis (A₂₂₀) of the optical means of the mating connector;
a secondary latching means for the optical means of the swivel connector is formed as a preferably inner housing wall of the mating-connector housing;
the mating-connector housing is formed such that in the closed position (G) an end face of the secondary latching means thereof holds the optical means of the swivel connector in a direction of the optical axis (A₂₂₀) of the optical means of the mating connector;
the optical means of the mating connector is an electrical optical converter, in particular an LED or a laser diode, and/or an optical electrical converter, in particular a photodiode or a phototransistor; and/or
the optical mating connector is a surface-mountable component, the electrical connections of which can be mounted on a substrate, with preferably both the optical means and an EMC protection means of the mating connector having surface-mountable electrical connections, in particular electrical connecting pins.

24. An optical connecting means for an optical, optoelectrical or optoelectronic device, e.g. an MOST device for the automotive sector, with an optical swivel connector, which can be provided and/or is provided on an optical mating connector such that
by means of the swivel connector a first optical means of the optical connecting means can be moved towards a second optical means of the optical connecting means, both optical means being able to be optically coupled together.

25. An optical connecting means according to claim 24, a bearing means of the swivel connector being able to be provided and/or being provided on/in a bearing means of the mating connector timewise before the establishing of an optical connection,
an axial direction (A₁₂₀) of the optical means of the swivel connector assuming an angle of preferably less than or mainly equal to 90° relative to an axial direction (A₂₂₀) of the optical means of the mating connector, and
the swivel connector being able to be pivoted out of an open position (O) on the mating connector into a closed position (G) on the mating connector, and in the closed position (G) being fastened, in particular latched, thereto.

26. An optical connecting means according to claim 24, wherein a bearing shell or the bearing surfaces of the bearing means of the mating connector spanning a substantially circular-cylindrical space, in which a bearing journal of the swivel connector can be provided and/or is provided to be rotatable;
the bearing journal having a substantially circular or oval, preferably elliptical, cross-section, and a distance between the major vertices of this cross-section corresponding substantially to a diameter of the space spanned by the bearing shell or the bearing surfaces.

27. An optical connecting means according to claim 24, wherein the bearing shell of the mating connector having a bearing slot such that the bearing journal of the swivel connector can be advanced therethrough into the bearing means,
a dimension of the bearing slot of the mating connector corresponding to at least one distance between the minor vertices of the cross-section of the bearing journal of the swivel connector.

28. An optical connecting means according to claim 24, wherein:
on a one-piece optical connecting means the swivel connector is provided to be pivotable on the mating connector;
on a two-piece optical connecting means the swivel connector is provided to be pivotable on the mating connector;
the two bearing means are configured such that they can be provided free of force on/in each other;
the two bearing means are configured such that they cooperate in substantially play-free manner upon pivoting the swivel connector on the mating connector;
in the closed position (G) exclusively a primary latching means of the swivel connector presses the optical means thereof against the optical means of the mating connector;
in the closed position (G) the optical means of the mating connector provides a spring force on the optical means of the swivel connector; and/or
the optical swivel connector is formed according to one of claim 16 or the optical mating connector is formed according to claim 20.

29. An assembled optical-waveguide cable, in particular pigtail, for an MOST device in the automotive sector, the assembled optical-waveguide cable having an optical swivel connector which is formed according to claim 16.

30. An electrical or electronic device for the automotive sector, or assembly therefor, the electrical or the electronic device or the assembly having an optical connecting means which is formed according to claim 24 or comprises an assembled optical-waveguide cable according to claim 29.
